(19) United States
(12) Patent Application Publication
(10) Pub. No.: US 2013/0037142 A1
(43) Pub. Date: Feb. 14, 2013

(54) DIALYSIS SYSTEM HAVING PERISTALTIC PUMP ARRANGEMENT

(71) Applicant: Sean Farrell, Fresno, CA (US)

(72) Inventor: Sean Farrell, Fresno, CA (US)

(73) Assignee: Fresenius Medical Care Holdings, Inc., Waltham, MA (US)

(21) Appl. No.: 13/204,981

(22) Filed: Aug. 8, 2011

(51) Int. Cl. F15D 1/00

(52) U.S. Cl. 137/565.01

(57) ABSTRACT

A system including a machine and a cassette that moves fluid from one source to another for use in dialysis. The machine includes at least a first set of pressure imposing valve actuators, said valve actuators being pneumatically operated and substantially adjacently disposed, and a cassette receiving portion. The cassette includes a housing adapted to be removably placed in the cassette receiving portion of the machine. The housing includes at least one inlet port adapted to be fluidly coupled to a fluid source, and at least one outlet port. The housing further includes an inlet manifold and a collection chamber, and at least one fluid pathway fluidly coupled to the two. In use, the fluid pathway disposed substantially adjacent the first set of valve actuators such that sequential actuation of the valve actuators moves a fluid through the pathways to the collection chamber.

### TECHNICAL FIELD

This patent disclosure relates generally to peristaltic pumps and, more particularly to dialysis systems utilizing a peristaltic pump.

### BACKGROUND

Peristaltic pumps are utilized in a variety of applications to feed fluids along a length of compliant or flexible tubing. Peristaltic pumps provide non-contact fluid flow, allowing the use of disposable tubing while maintaining the integrity of the fluid path. Peristaltic pumps are particularly useful in pumping arrangements for corrosive materials or hygienic materials because the pumped material does not come into contact with the mechanical structures defining other parts of the pump.

Peristaltic pumps include compression units, generally in the form of rollers, that compress the tubing against a raceway. Successive rollers capture a “pillow” of fluid within the tubing, pushing the pillow forward as the rollers progress along the tubing.

### SUMMARY

The disclosure describes, in one aspect, a system for moving fluid from one source to another for use in dialysis. The system includes a machine and a cassette. The machine includes at least three sets of pressure imposing valve actuators, the valve actuators in each set being substantially adjacently disposed, and a cassette receiving portion. The cassette includes a housing adapted to be removably placed in the cassette receiving portion of the machine. The housing includes at least one inlet port adapted to be fluidly coupled to a fluid source, and at least one outlet port. The housing defines an inlet manifold and at least three fluid pathways fluidly coupled to the inlet manifold. The inlet manifold is fluidly coupled to the inlet port upstream of the inlet manifold. The housing further includes a collection chamber fluidly coupled to the outlet port. The outlet port is disposed downstream of the collection chamber. The fluid pathways extend parallel flow from the inlet manifold upstream of the fluid pathways to the collection chamber downstream of the fluid pathways. The fluid pathways are adapted to be disposed substantially adjacent respective sets of the valve actuators such that sequential actuation of the valve actuators moves a fluid through the pathways to the collection chamber.

In another aspect, the disclosure describes a system for moving fluid from one source to another in dialysis. The system includes a machine and a cassette. The machine includes at least a first set of substantially adjacently disposed pressure imposing valve actuators, and a cassette receiving portion. The valve actuators are pneumatically operated. The cassette includes a housing adapted to be removably placed in the cassette receiving portion of the machine. The housing includes at least one outlet port, and at least one inlet port adapted to be fluidly coupled to a fluid source. The housing also includes an inlet manifold and at least one fluid pathway fluidly coupled to the inlet manifold. The inlet manifold is fluidly coupled to the inlet port upstream of the manifold. The housing further includes a collection chamber fluidly coupled to the outlet port. The outlet port is disposed downstream of the collection chamber. The fluid pathway extends from the inlet manifold upstream of the fluid pathway to the collection chamber downstream of the fluid pathway. The fluid pathway is adapted to be disposed substantially adjacent the first set of valve actuators such that sequential actuation of the valve actuators moves a fluid through the pathway to the collection chamber.

In a further aspect, the disclosure describes a cassette for use in a dialysis machine to move fluid from one source to another. The machine includes at least three sets of substantially adjacently disposed pressure imposing valve actuators. The cassette includes a housing adapted to be removably placed in the machine. The housing includes at least one inlet port adapted to be fluidly coupled to a fluid source, and at least one outlet port. The housing includes an inlet manifold. The inlet manifold is fluidly coupled to the inlet port, the inlet port being disposed upstream of the manifold. The housing further includes at least three fluid pathways fluidly coupled to the inlet manifold. The housing includes a collection chamber fluidly coupled to the outlet port, the outlet port being disposed downstream of the collection chamber. The at least three fluid pathways extend parallel flow from the inlet manifold upstream of the fluid pathways to the collection chamber downstream of the fluid pathways. The fluid pathways are adapted to be disposed substantially adjacent respective sets of valve actuators such that sequential actuation of the valve actuators moves fluid through the pathways to the collection chamber.

### BRIEF DESCRIPTION OF THE DRAWING(S)

FIG. 1 is an exemplary dialysis machine including a disclosed system.

FIG. 2 is a front elevational view of a cassette disposed within the dialysis machine of FIG. 1.

FIG. 3 is a schematic representation of a control arrangement for actuation of elements of the machine of FIGS. 1 and 2. Components not discussed within this disclosure not being illustrated in FIG. 3.

FIG. 4 is a plan view of the cassette of FIG. 2.

FIG. 5 is a plan view of an alternate embodiment of a cassette.

### DETAILED DESCRIPTION

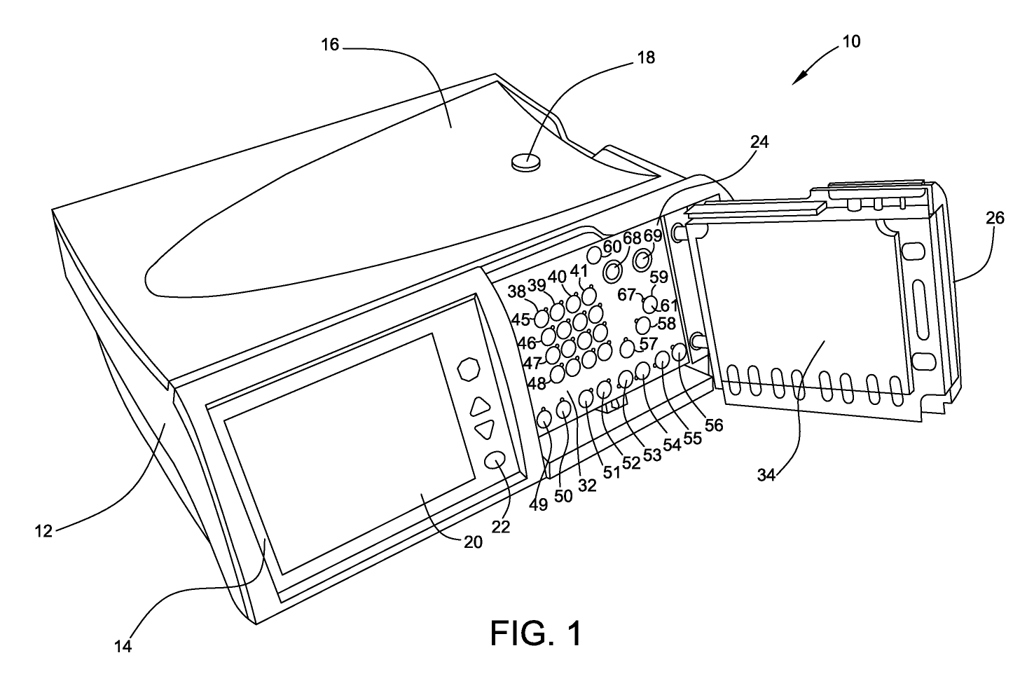

Turning now to the figures, FIG. 1 illustrates an exemplary machine 10 for use in dialysis. While the machine 10 may be of any appropriate configuration, and may include any appropriate systems and features, the illustrated machine 10 includes a housing 12 having a control panel 14, and a warming tray 16. The warming tray 16 of the illustrated embodiment is disposed generally on the upper portion of the machine 10 and is adapted to support a vessel of fluid as in a bag or the like (not shown). The warming tray 16 may be heated by electronic elements (not shown) or the like to impart heat to the supported fluid bag, although an alternate fluid heating arrangement may be provided. The warming tray 16 may include a temperature sensor 18 disposed to sense a temperature corresponding to the temperature of the fluid within a supported bag such that the temperature of the warming tray 16 may be adjusted to warm the fluid or maintain the fluid at a desired temperature.

The control panel 14 may include a display screen 20 as well as one or more actuating buttons 22 for directing the operation of the machine 10. The display screen 20 may merely display various informational screens or, alternatively, may be a touch screen such that the user may interact directly with the screen 20 to control operation of the machine 10.

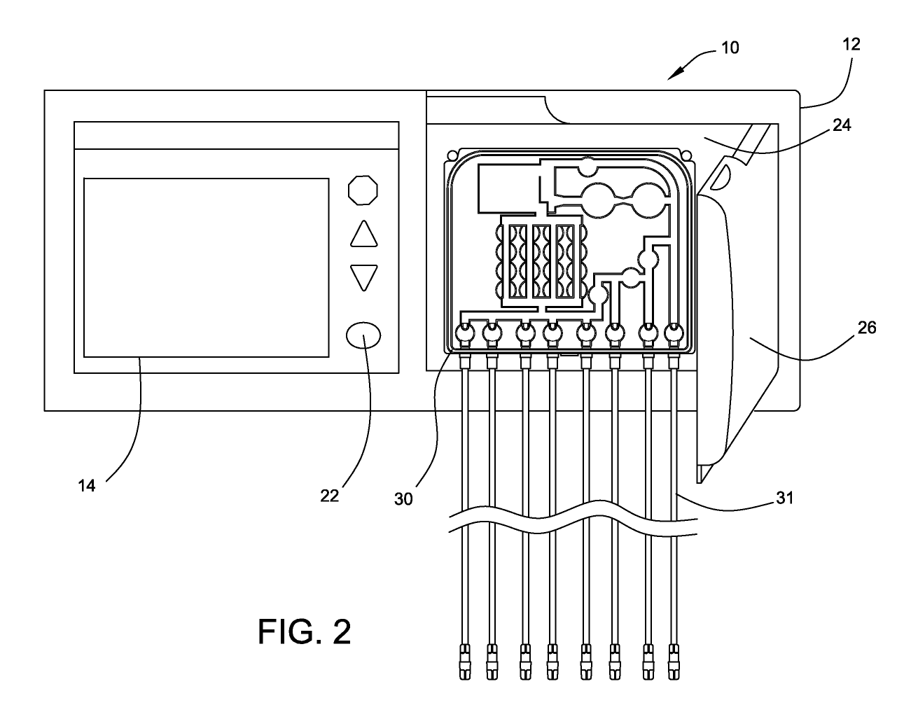

The housing 12 additionally defines a cassette receiving portion 24, and may include a cover 26 that may be coupled to the housing 12 to substantially surround faces of a replaceable cassette 30, as shown, for example, in FIG. 2, when the cover 26 is in a closed position. The cassette receiving portion 24 includes faces 32, 34 that are disposed against respective faces of the cassette 30 when the cassette is positioned within the cassette receiving portion 24 and the cover 26 is closed. In the illustrated embodiment, the cover 26 is hingedly coupled to the housing 12, although it may be alternately coupled or couplable to the housing 12. Those of skill in the art will appreciate that the machine 10, including the housing 12 and/or the cover 26, may include any appropriate system for maintaining and/or locking the cover 26 to the housing 12 in a closed position. It will further be appreciated that the machine 10 may include one or more systems for ensuring secure seating of the cassette 30 within the cassette receiving portion 24. Such systems may include, by way of example only, the inflation of a bladder (not illustrated) to increase pressure on the cassette 30 disposed within the cassette receiving portion 24.

Referring to FIG. 1, the machine 10 further includes a plurality of structures disposed to interact with a cassette 30 disposed within the cassette receiving portion 24. The machine 10 may include a plurality of valve actuators 45-60 disposed to control flow through the cassette 30, as will become apparent upon the further description of the cassette 30, below. In the illustrated embodiment, an array 36 of four columns 38-41, each with four valve actuators 45-48 is provided. Valve actuators 49-56 are disposed along the lower portion of the face 32 of the cassette receiving portion 24, while valve actuators 57-60 are disposed along the remaining areas of face 32. It will be apparent from the description below that the array 36 may include alternate numbers of columns 38-41 and alternate numbers of valves actuators 45-48, and that the remaining valve actuators 49-60 may be of another number, and may be alternately disposed, depending upon the design of the cassette 30.

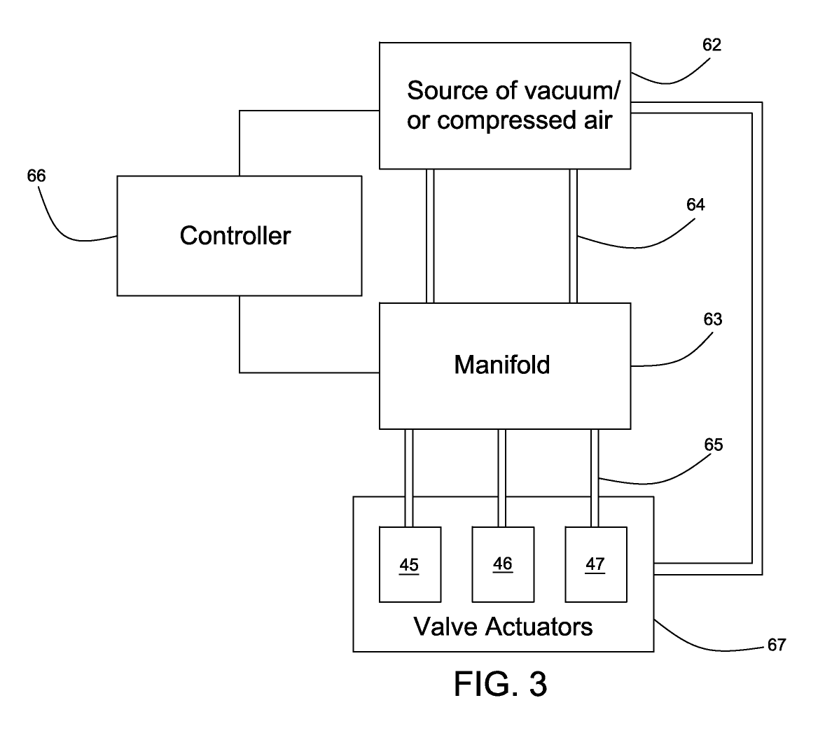

The valve actuators 45-60 may be of any appropriate design. For example, in the illustrated embodiment, the valve actuators 45-60 are pneumatically operated, each of the valve actuators 45-60 presenting a membrane 61 to the cassette receiving portion 24. Referring to FIG. 3, to this end, one or more sources 62 of a vacuum and/or compressed air are provided within the housing 12. While only three such valve actuators 45-47 are illustrated in the schematic of FIG. 3, it will be appreciated that any or all such actuators 45-60 may be operated pneumatically, as illustrated, or operated by an alternate arrangement, such as, for example, by mechanical actuators. In FIG. 3, the vacuum and/or compressed air are provided to a manifold 63 by one or more fluid connections 64, and on to the respective valve actuators 45-47 by one or more fluid connections 65. It will be appreciated that generally each such valve actuator 45-60 would have a dedicated fluid connection 65. The manifold 63 may be controlled or directed by a controller or other suitable arrangement 66. In this way, compressed air may be selectively provided to the individual valve actuators 45-60 to expand the respective membrane 61, or compressed air may be released to deflate the membrane 61.

Returning to FIG. 1, one or more vacuum outlets 67 may be provided adjacent the individual membranes 61 of the valve actuators 45-60 in order to provide a channel for conveying a vacuum between the membranes 61 of the valve actuators 45-60 and the adjacent surfaces of a loaded cassette 30. The vacuum outlets 67 may be small openings substantially adjacent the membranes 61 of the valve actuators 45-60 that permit a vacuum to be channeled directly to the interface between the cassette 30 and the surface of the cassette receiving portion 24. In this way, the vacuum directed to through the vacuum outlets 67 generally ensures that the flexible membrane 82 of the cassette 30 (see discussion below) follows the membranes 61 of the valve actuators 45-60 when the pneumatic pressure is released from the valve actuators 45-60. The vacuum may be provided to the space between membranes 61 of the valve actuators 45-60 and the flexible membrane 82 of the cassette 30 by way of individual delivery channels (not illustrated), or by way of a general vacuum applied to a rear surface of the face 32 of the cassette receiving portion 24, as illustrated in FIG. 3.

The machine 10 further may additionally present one or more sensors or the like to the cassette receiving portion 24. In the illustrated embodiment, a pair of pressure sensors 68, 69 are provided. The pressure sensors 68, 69 may be of any appropriate design that may be known now or developed in the future in order to measure pressure within chambers of an adjacently disposed cassette 30. It will be appreciated that additional sensors, such as temperature sensors (not shown) or the like, may be provided.

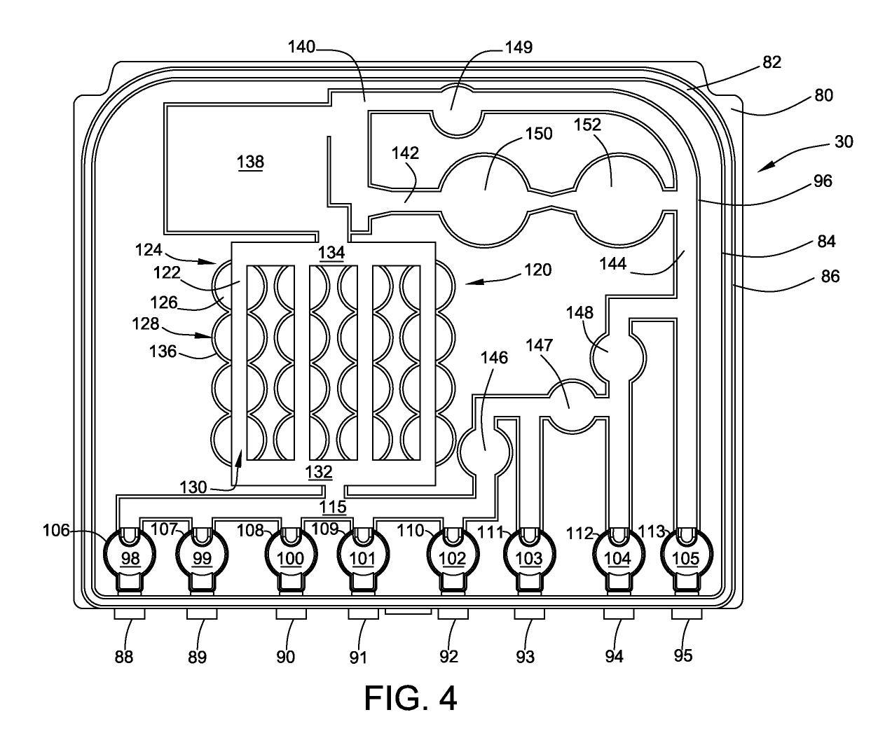

Turning to FIG. 4, there is illustrated an exemplary cassette 30 for use with the machine 10 of FIG. 1. The illustrated cassette 30 includes a relatively rigid formed polymeric panel 80 to which a flexible membrane 82 is secured at a pair of concentric, raised ridges 84, 86 about the periphery of the formed panel 80. The formed panel 80 includes a plurality of ports 88-95 to which tubes 31 (see FIG. 2) may be secured to provide flow to or from one or more external vessels (not shown) or the like to the space between the formed panel 80 and the flexible membrane 82. At least one of the ports 88-95 is an inlet port and at least one of the ports is an outlet port. In an embodiment, the substantially rigid polymeric panel 80 is injection molded, although it may be alternately formed.

The formed panel 80 additionally includes a plurality of raised ridges 96 that, along with the flexible membrane 82 form a plurality of channels, valves, and chambers when the flexible membrane 82 is sealingly pressed to the formed panel 80. More specifically, the raised ridges 96 of the cassette 30 form a plurality of recessed areas that form various pathways and components of the cassette 30 when the flexible membrane 82 is pressed into sealing contact with the formed panel 80. The raised ridges 96 forming the generally circular recessed areas 98-105 along the lower portion of the cassette 30 (as illustrated) form valves 106-113 that control flow through the adjacently disposed ports 88-95 of the formed panel 80. When the cassette 30 is disposed within the machine 10, the valves 106-113 are disposed adjacent the valve actuators 49-56. In this way, flow through each valve 106-113 is prevented when the flexible membrane 82 is pressed into the respective recessed area 98-105, i.e., when compressed air is supplied to the valve actuators 49-56 to actuate the corresponding valve 106-113. Conversely, flow through each valve 106-113 is permitted when the membrane 82 is not pressed into contact with the respective recessed area 98-105, i.e., when compressed air is not supplied to the valve actuators 49-56. While the recessed areas 98-105 are preferably generally concave such that the membrane 82 protrudes into the concave portion of the recessed area 98-105 of the formed panel 80 to block flow through the respective valve 106-113 when the corresponding valve actuator 49-56 is operated.

The raised ridges 96 additionally form a first inlet manifold 115. Flow to the first inlet manifold 115 from ports 88-92 is controlled by valves 106-110, which may be actuated by valve actuators 49-53.

In order to move fluid through the cassette 30, a peristaltic pumping assembly 120 is provided. The pumping assembly 120 includes a plurality of tubes 122 and an array 124 of pinch valves 126 in a plurality of rows 128 and columns 130, the columns 130 corresponding in number to the number of tubes 122. In the illustrated embodiment, the tubes 122 are disposed in a parallel arrangement, providing a compact structure. A second inlet manifold 132 and an outlet chamber 134 are fluidly coupled to either end of the tubes 122 such that flow from the first inlet manifold 115 is directed to the second inlet manifold 132 from which flow proceeds through the tubes 122 to the outlet chamber 134. It will be appreciate by those of skill in the art that fluid from the second inlet manifold 132 is pushed through the tubes 122 to the outlet chamber 134 as the valves 126 adjacent the tubes 122 are sequentially actuated. In this way, a volume of fluid is trapped in the tube and moved along the length of the tube 122 as the valves 126 along the tube 122 are sequentially actuated.

In the embodiment of FIG. 4, the tubes 122, second inlet manifold 132 and outlet chamber 134 of the peristaltic pumping assembly 120 are a separately formed subassembly that is secured to the panel 80 and/or the flexible membrane 82 during the assembly process. In assembly, the tubes 122 are disposed adjacent valves 126 formed in the panel 80; the valves 126 may be concave or flat structures defined by way of a plurality of raised ridges 136. Alternately, the second inlet manifold 132, outlet chamber 134, and tubes may be integrally formed with the panel 80.

The tubes 122 may be formed of any material that is sufficiently resilient to allow for the opening and closing of the tube 122 as the adjacent valves 126 are sequentially actuated along the length of the tube 122. The tubes 122 may, for example, be formed of a material such as polyurethane or nylon. They may be insert molded with the polymeric panel 80 or attached to the cassette 30 post molding of the polymeric panel 80. In this regard, the tubes 122 are preferably secured to the polymeric panel 80, although they may alternatively or additionally be secured to the flexible membrane 82, when such a membrane 82 is provided.

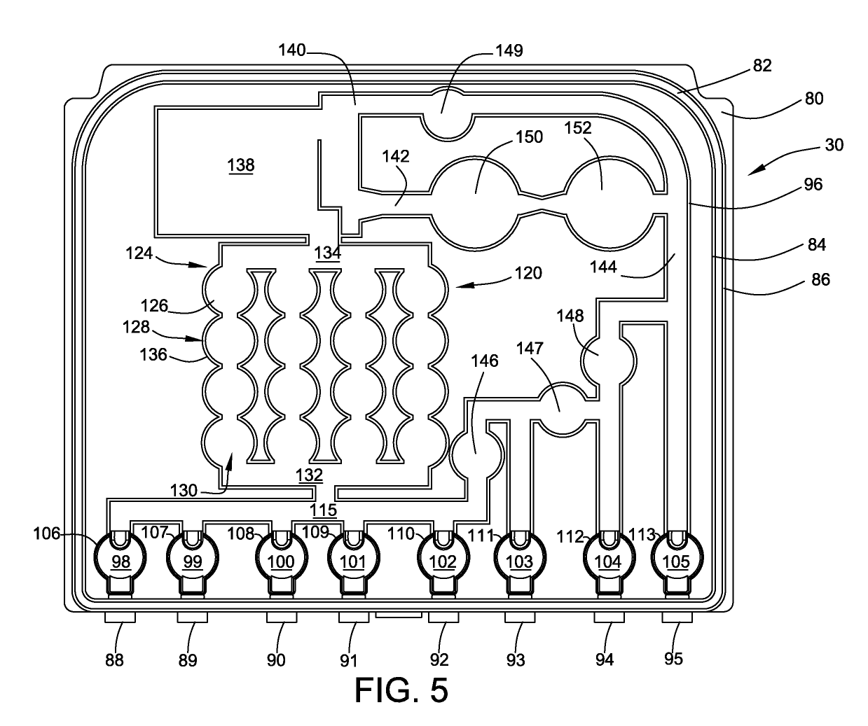

The same reference numbers are utilized in the alternate embodiment of FIG. 5 as are utilized for similar or the same structures in FIG. 4. In the alternate embodiment of FIG. 5, the array 124 of valves 126 is formed by the panel 80 and the membrane 82, but no tubes are provided. Rather, a plurality of flow paths are provided through the valves 126 themselves, which are formed adjacently in the panel 80 such that sequential actuation of the valves 126 along each column 130 moves fluid from the second inlet manifold 132 through the column of valves 126 to the outlet chamber 134.

In operation, the valves 126 in each column 130 are sequentially operated, trapping a volume of fluid in the tube 122 (FIG. 4) or the valve 126 (FIG. 5) and moving it along the length of the column 130 by cycling subsequent valves 126. The operation of the valves 126 in the various rows 128 is preferably staggered so that there is a continual flow of fluid between the second inlet manifold 132 and the outlet chamber 134, and surges are minimized. In order to further provide for a relatively constant pressure and velocity fluid flow, a collection chamber 138 is provided downstream of the outlet chamber 134. The collection chamber 138 allows for the pulsing flow of each of the columns 130 of valves 126 of the pump array 120 to collect and normalize. As a result, the outlet flow from the collection chamber 138 is a generally constant flow stream.

Downstream of the collection chamber 138, the flow path splits into two flow paths 140, 142 that later rejoin in a single path 144. As flow proceeds through the flow path 144, flow to the various ports 93-95 is controlled by the actuation of not only valves 111-113 by valve actuators 54-56, but also directional control valves 146-148, actuation of which is controlled by valve actuators 57-59. An opening of valve 146 allows flow to proceed to or from the first inlet manifold 115.

Returning to the flow from the first and second flow paths from the collection chamber 138, those of skill in the art will appreciate that, when the cassette 30 is generally vertically disposed, air from the collection chamber 138 would generally rise to the first flow path 140, in which an air relief valve 149 is provided. When air is sensed in the system, the air relief valve 149 may be opened by releasing pressure in valve actuator 60 (see FIG. 1), to open the first flow path 140 and flush fluid with entrained air through path 144 and generally out of one of ports 93-95 to a drain (not shown) when an adjacent valve 111-113 is opened by removing pressure from exerted by a respective one of valve actuators 54-56.

During most flow operations, however, air relief valve 149 remains closed, and flow is directed through the second flow path 142. In order to provide monitoring as desired, a pair of pressure sensing chambers 150, 152 are provided along the second flow path 142. The pressure sensing chambers 150, 152 are disposed adjacent the pressure sensors 68, 69 such that the pressure sensors 68, 69 may be operated to determine the pressure of fluid flowing from the collection chamber 138. It will be appreciated that the relatively constant flow stream from the collection chamber 138 allows for accurate pressure readings in within the pressure sensing chambers 150, 152.

While the cassette 30 has been described with regard to flow through certain flow paths and the operation of certain valves, the cassette 30 may be of an alternate design. For example, it may include a pair of flexible membranes with a substantially rigid frame, so long as structures corresponding to the pump array 120 as well as selectively actuatable valves interfacing with flow paths of some appropriate arrangement are formed therein when the cassette 30 interfaces with the machine 10. Further, as explained above, the cassette 30 may be fabricated by any appropriate method.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A system for use in dialysis, the system moving fluid from one source to another, the system comprising:
a machine including
at least three sets of substantially adjacently disposed pressure imposing valve actuators, and
a cassette receiving portion,
a cassette comprising:
a housing adapted to be removably placed in the cassette receiving portion of the machine, the housing including at least one inlet port adapted to be fluidly coupled to a fluid source, and at least one outlet port; the housing including
an inlet manifold, the inlet manifold being fluidly coupled to the inlet port, the inlet port being disposed upstream of the inlet manifold;
at least three fluid pathways fluidly coupled to the inlet manifold;
a collection chamber fluidly coupled to the outlet port, the outlet port being disposed downstream of the collection chamber;
the fluid pathways extending parallel flow from the inlet manifold upstream of the fluid pathways to the collection chamber downstream of the fluid pathways, the fluid pathways being adapted to be disposed substantially adjacent respective sets of the valve actuators such that sequential actuation of the valve actuators moves a fluid through the pathways to the collection chamber.

2. The system of claim 1 wherein the cassette further includes an air relief valve downstream of the collection chamber.

3. The system of claim 1 wherein the machine further includes a pressure sensor, and the cassette further comprises downstream of the collection chamber first and second pressure chambers connected by a flow restrictor, at least one of the pressure chambers being adapted to be disposed substantially adjacent the pressure sensor.

4. The system of claim 1 wherein the cassette further comprises an outlet manifold disposed upstream of the collection chamber and downstream of the fluid pathways, the outlet manifold being fluidly coupled to the fluid pathways such that fluid flowing through the pathways passes through the outlet manifold before flowing to the collection chamber.

5. The system of claim 1 wherein the cassette comprises at least one flexible membrane coupled to the housing, the flexible membrane forming a wall of the collection chamber.

6. The system of claim 5 wherein the flexible membrane forms a portion of at least the inlet manifold and the collection chamber.

7. The system of claim 5 wherein the valves are pneumatically operated.

8. The system of claim 1 wherein the valves are pneumatically operated.

9. A system for use in dialysis, the system moving fluid from one source to another, the system comprising:
a machine including
at least a first set of pressure imposing valve actuators, said valve actuators being pneumatically operated and substantially adjacently disposed, and
a cassette receiving portion,
a cassette comprising:
a housing adapted to be removably placed in the cassette receiving portion of the machine, the housing including at least one inlet port adapted to be fluidly coupled to a fluid source, and at least one outlet port; the housing including
an inlet manifold, the inlet manifold being fluidly coupled to the inlet port, the inlet port being disposed upstream of the inlet manifold;
at least one fluid pathway fluidly coupled to the inlet manifold;
a collection chamber fluidly coupled to the outlet port, the outlet port being disposed downstream of the collection chamber;
the fluid pathway extending from the inlet manifold upstream of the fluid pathway to the collection chamber downstream of the fluid pathway, fluid pathway being adapted to be disposed substantially adjacent the first set of valve actuators such that sequential actuation of the valve actuators moves a fluid through the pathways to the collection chamber.

10. The system of claim 9 wherein the machine comprises at least two sets of valve actuators, and the cassette includes at least two fluid pathways fluidly extending between the inlet manifold and the collection chamber, the at least two fluid pathways providing parallel flow paths adjacent the at least two sets of valve actuators, sequential actuation of the valve actuators within the respective sets of valve actuators moving fluid from the inlet manifold to the collection chamber.

11. The system of claim 9 wherein the cassette further includes an air relief valve downstream of the collection chamber.

12. The system of claim 9 wherein the machine further includes a pressure sensor, and the cassette further comprises downstream of the collection chamber first and second pressure chambers connected by a flow restrictor, at least one of the pressure chambers being adapted to be disposed substantially adjacent the pressure sensor.

13. The system of claim 9 wherein the cassette further comprises an outlet manifold disposed upstream of the collection chamber and downstream of the fluid pathway, the outlet manifold being fluidly coupled to the fluid pathway such that fluid flowing through the pathway passes through the outlet manifold before flowing to the collection chamber.

14. The system of claim 9 wherein the cassette comprises at least one flexible membrane coupled to the housing, the flexible membrane forming a portion of at least the collection chamber.

15. A cassette for use in a dialysis machine to move fluid from one source to another, the machine including at least three sets of substantially adjacently disposed pressure imposing valve actuators, the cassette comprising:
a housing adapted to be removably placed in the machine, the housing including at least one inlet port adapted to be fluidly coupled to a fluid source, and at least one outlet port; the housing including
an inlet manifold, the inlet manifold being fluidly coupled to the inlet port, the inlet port being disposed upstream of the inlet manifold;
at least three fluid pathways fluidly coupled to the inlet manifold;
a collection chamber fluidly coupled to the outlet port, the outlet port being disposed downstream of the collection chamber;
the at least three fluid pathways extending parallel flow from the inlet manifold upstream of the fluid pathways to the collection chamber downstream of the fluid pathways, the fluid pathways being adapted to be disposed substantially adjacent respective sets of valve actuators such that sequential actuation of the valve actuators moves fluid through the pathways to the collection chamber.

16. The cassette of claim 15 further including an air relief valve downstream of the collection chamber.

17. The cassette of claim 15 further including downstream of the collection chamber first and second pressure chambers connected by a flow restrictor, at least one or the pressure chambers being adapted to be disposed substantially adjacent a pressure sensor.

18. The cassette of claim 15 further comprising an outlet manifold disposed upstream of the collection chamber and downstream of the fluid pathways, the outlet manifold being fluidly coupled to the fluid pathways such that fluid flowing through the pathways passes through the outlet manifold before flowing to the collection chamber.

19. The cassette of claim 15 further comprising at least one flexible membrane coupled to the housing, the flexible membrane forming a portion of at least the collection chamber.

20. The cassette of claim 19 wherein the flexible membrane forms a portion of the inlet manifold.
